(19) United States
(12) Patent Application Publication
(10) Pub. No.: US 2012/0118031 A1
(43) Pub. Date: May 17, 2012

(54) SECURITY APPARATUS INCLUDING POWER ATTACHMENT DEVICE

(76) Inventors: John Hung, Vancouver (CA); Robert Mahaffey, Vancouver (CA); John Cavacuiti, North Vancouver (CA); Colin R. Adamson, North Vancouver (CA)

(21) Appl. No.: 13/293,615

(22) Filed: Nov. 10, 2011

Related U.S. Application Data
(60) Provisional application No. 61/412,631, filed on Nov. 11, 2010.

(51) Int. Cl. E05B 73/00; E05B 47/00

(52) U.S. Cl. 70/279.1; 70/277

(57) ABSTRACT

A security apparatus is disclosed. The security apparatus comprises an attachment device comprising an outer portion, and a locking head configured to secure to the outer portion. The locking head can have a securing element and a locking component, associated with a housing. The locking head may be in a secured configuration upon a single motion or movement of the locking head, and may electrically couple to the attachment device through an electrical connector. The security apparatus can provide both security and power or other electrical signals for the portable article.

### CROSS-REFERENCES TO RELATED APPLICATIONS

This application is a non-provisional application of and claims the benefit of priority of U.S. Provisional Application No. 61/412,631, filed on Nov. 11, 2010, which is herein incorporated by reference in its entirety for all purposes.

### BACKGROUND

Computers have evolved rather rapidly from large, expensive machines usable only by a few, to relatively small, portable machines which are usable by many. In particular, the development of smaller desktop or laptop (e.g., notebook or tablet) computers with significant processing power has made computers available to the general population. It is now common for college and even high school students to have their own computer, and laptop computers are in wide spread use as word processors and work stations in almost all forms of business. Laptop computers are relatively small and easily transportable, and an undesirable side effect of their proliferation is the fact that the theft of such computers is a significant problem.

A variety of devices have been developed to inhibit the theft of computers, such as laptop or desktop computers and similar equipment. Since desktop computer systems involve several components, typically including the computer itself, a separate monitor, keyboard and often a printer, such security systems often employ a cable which attaches each of the components to each other and to a relatively immovable object such as a desk. The principal difficulty in such systems is providing an effective and convenient method for attaching the cable itself to the equipment.

One way to address the problem of computer security is to provide a small, generally rectangular slot in a wall of a computer. A security apparatus with a locking head may be secured to the computer via the rectangular slot.

While this solution can be effective, improvements could be made. For example, the security apparatus can take a number of steps to attach to the slot. A user needs to align the security apparatus locking head with the slot, and then needs to turn a key to rotate a T-bar to a locked configuration. This takes a number of steps and requires a fair amount of effort on the part of the user. It would be desirable to secure a computer to an immovable object with a security apparatus in fewer steps. Further, some computer manufacturers may want to use a different solution that can adapt to more slots other than a typical rectangular slot, or that can adapt to other types of computer configurations.

Another problem to be solved is the need to reduce the number of connections, mechanical and/or electrical, to portable devices such as portable computers. For example, as computers become smaller and thinner, the real estate around the peripheries of such computers becomes more valuable. For example, a security slot that is separate from a power port, data ports, and peripheral ports could be provided on a laptop computer. However, the presence of the separate security slot takes up space that could otherwise be used for a data port or peripheral port. It would be desirable to provide for a solution to this problem.

Embodiments of the invention address these and other problems, individually and collectively.

### BRIEF SUMMARY

Embodiments of the invention relate to security apparatuses, as well as methods for making and using security apparatuses. Embodiments of the invention can be used to provide power to a portable device, or data to or from the portable device, through a security apparatus. In some embodiments, the security apparatus can have a removable connector that allows the security apparatus to connect to different attachment devices.

One embodiment of the invention is directed to a security apparatus comprising an attachment device configured to attach to a portable article, and a locking head configured to secure to the attachment device. The locking head comprises an electrical connector that is capable of being electrically coupled to the attachment device.

Another embodiment of the invention is directed to a locking head comprising a housing, a locking component in the housing, an electrical connector exposed by the housing, and at least two coupling elements configured to engage an attachment device attached to a portable article.

Another embodiment of the invention is directed to a method for using the security apparatus, as described above, comprising attaching the locking head to the attachment device, thereby electrically coupling the locking head to the attachment device and the portable article.

These and other embodiments of the invention are described in further detail below.

### BRIEF DESCRIPTION OF THE DRAWINGS

FIG. 1 shows a front perspective view including a portion of a portable article and a security apparatus.

FIG. 2A shows a rear perspective view including a portion of a portable article and a security apparatus.

FIG. 2B shows an exploded view of a locking head and its corresponding connector tip.

FIG. 3 shows an exploded view of a security apparatus according to an embodiment of the invention.

FIG. 4A shows a side, cross-sectional view of a security apparatus, before the locking head engages the attachment device.

FIG. 4B shows a side, cross-sectional view of a security apparatus in a locked configuration.

FIG. 5A shows a bottom perspective view of a locking head according to an embodiment of the invention.

FIG. 5B shows a bottom, cross-sectional, perspective view of a locking head showing internal components. The state of the locking head is after an electrical connector engages the attachment device, but the locking head is in an unlocked configuration.

FIG. 5C shows a side, cross-sectional view of a locking head, after the electrical connector engages the attachment device but the locking head is still in an unlocked configuration.

FIG. 6A shows a bottom, cross-sectional, perspective view of a locking head showing internal components in a locked configuration.

FIG. 6B shows a bottom, cross-sectional, perspective view of a locking head showing internal components. The state of the locking head is after an electrical connector engages the attachment device, but the locking head is in a locked configuration.

FIG. 6C shows a side, cross-sectional view of a locking head, after the electrical connector engages the attachment device but the locking head is still in a locked configuration in a locked configuration.

FIG. 7 shows a side, cross-sectional view of a locking head in a locked configuration.

FIG. 8 shows a system according to an embodiment of the invention.

These and other embodiments are described in further detail below in the Detailed Description. In the Figures, like numerals may designate like elements and descriptions of like elements may not be repeated for all Figures.

### DETAILED DESCRIPTION

Embodiments of the invention are directed to security apparatuses, methods for making and using such security apparatuses, and systems using such security apparatuses. The security apparatuses can be used to prevent or deter the theft of devices such as portable electronic devices. The security apparatuses can also supply power or be electrically coupled to the portable electronic devices.

One embodiment of the invention is directed to a security apparatus comprising an attachment device comprising an outer portion, and also a head (e.g., a “locking head”). The head comprises (i) a housing, (ii) a gate structure within the housing and configured to engage the outer portion of the attachment device, (iii) an electrical connector configured to electronically couple the locking head to the attachment device, and (iv) a locking component inside of the housing.

A security apparatus according to an embodiment of the invention may comprise a head and a security device. The head and the security device may be physically (e.g., using a pin or other suitable connection) and/or operationally (e.g., wirelessly, etc.) coupled together.

The security device may comprise a cable, or some other type of device to provide security. If the security device comprises a cable, then the cable may be secured to an immovable object such as a desk or cabinet so that a portable electronic device coupled to the cable cannot be removed. The cable may comprise stainless steel, carbon steel, Kevlar®, or some other type of strong material. In exemplary embodiments, the strong material may be chosen to have high tensile strength and/or cut resistance strength.

In another embodiment, the security device may comprise a wireless device such as a wireless transmitter and/or receiver. The wireless device may be used in a proximity detection system or a motion detection system. For example, a motion detector could be present in the wireless device so that when the motion detector moves, an associated alarm is triggered. The alarm may be in the security device or may be external to the security device. In another embodiment, there may be a base device associated with the wireless device, and these components may be used in a proximity detection system. Wireless signals may be transmitted between the security device and the base device, and when these devices are separated by a predetermined distance, an associated alarm (e.g., an audible alarm) may be triggered. The alarm could be in the base device or in the security device. The electronics associated with such wireless systems are known to those of ordinary skill in the art.

The head in the security apparatus may be a locking head. A locking head according to an embodiment of the invention may comprise a locking component (e.g., a locking mechanism) such as a key locking component or a combination locking component disposed within it. As used herein, a “locking component” may comprise one or more structures suitable for causing the head to be in locked and unlocked configurations (i.e., locked or unlocked states). Various types of locking heads are described in further detail below.

The portable article that is to be secured may comprise any suitable article, such as a portable device (e.g., a portable electronic device). Examples of such articles comprise portable computers such as laptop, tablet, desktop, and server computers, flat panel televisions, projectors, monitors, portable music players, printers, external hard-drives, cell phones, etc. Other types of articles may include medical devices that may or may not have electronics in them, industrial devices such as power or pneumatic tools, or sporting goods (bicycles, golf equipment such as golf bags, hockey equipment, etc.). In exemplary embodiments, the portable article that is to be secured may be a hand-carried article (e.g., an article capable of carried by a typical user without assistance).

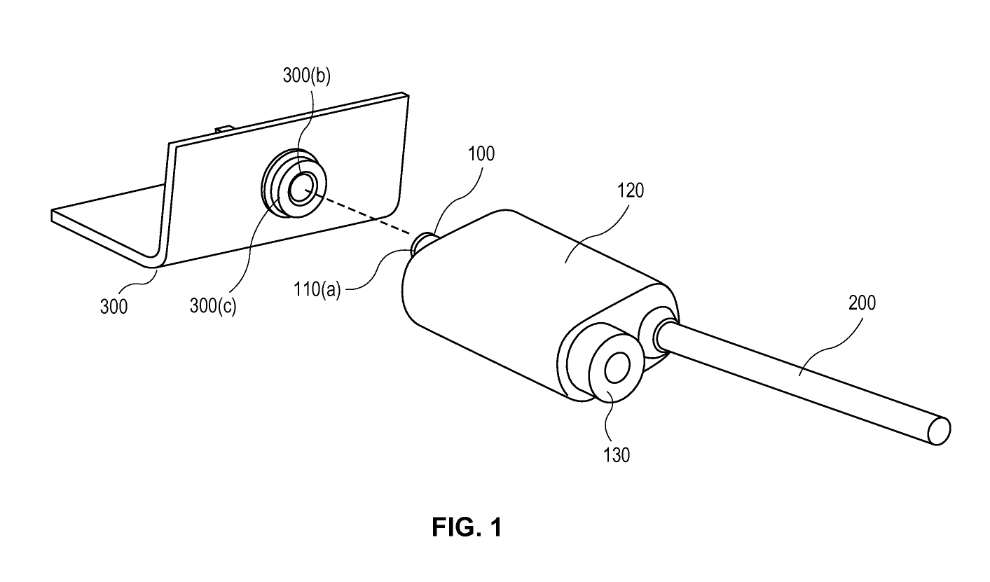

FIGS. 1-8 show external, exploded, and internal views of an embodiment of the invention in which the security apparatus may also provide power to a portable article. The security apparatus of certain embodiments can comprise an attachment device configured to attach to a portable article, and a locking head configured to secure to the attachment device. The locking head can be electrically coupled to the portable article through the attachment device.

FIG. 1 shows a portion of a portable article housing 300 associated with a portable article (.g., a laptop computer). An attachment device 300 may be secured to the portable article housing 300 via a hole. The attachment device 300(c) may comprise an aperture 300(b). The aperture 300(b) may be a through aperture, which may be in the form of a hole, or a recess. The aperture 300(b) may pass through an axial dimension of the attachment device 300(c). In certain embodiments, an attachment device 300(c), which may comprise a security anchor with female electrical contacts, may be secured to the aperture 300(b), by any suitable method such as disclosed herein. For example, the attachment device 300(c) may have an outer portion located outside the housing 300, and an inner portion formed within the housing 300. Both the outer portion and the inner portion may be larger than the aperture 300(b) and connected to each other, so that the attachment device 300(c) may not be removed from the portable article without at least damaging the portable article housing 300. In exemplary embodiments, the attachment device 300(c) may be electrically coupled to one or more electrical systems (e.g., a power system) associated with the portable article.

Referring to FIG. 1, a locking head 120 may be configured to mechanically couple to the attachment device 300(c). The locking head 120 can comprise a locking head housing, and an electrical connector 100 with a male adapter member 110(a) extending from the locking head housing. The locking head 120 and attachment device 300(c) may be capable of transmitting power to the portable article and may be capable of securing the portable article to an immovable object. Power to the portable article 300 may be transmitted through the attachment device 300(c), which can be electrically coupled to the electrical connector 100 of the locking head 120 when the attachment device 300(c) and the locking head 120 are secured to each other. The electrical connector 100 may be part of a connector tip 110 or any other suitable connector. Although the electrical connector 100 is shown as a tip in the exemplary embodiments shown in FIG. 1, the electrical connector 100 may have any suitable form. It may be in the form of a power tip, a USB connector, etc.

As shown in FIG. 1, the locking head 120 may in turn be physically and electrically coupled to a security device 200 which can comprise a power cable. The security device 200 may be connected to an external power source (not shown) (e.g., an outlet or battery). The security device may also be secured to an immovable object such as a desk or cabinet so that a portable article coupled to the security device cannot be removed. A ferrule 130 may extend outwardly from the locking head 120 and may comprise an opening that allows outside access to a locking component (not shown) within the locking head 120. A key (not shown) may be used with the locking component to lock and unlock the locking head 120.

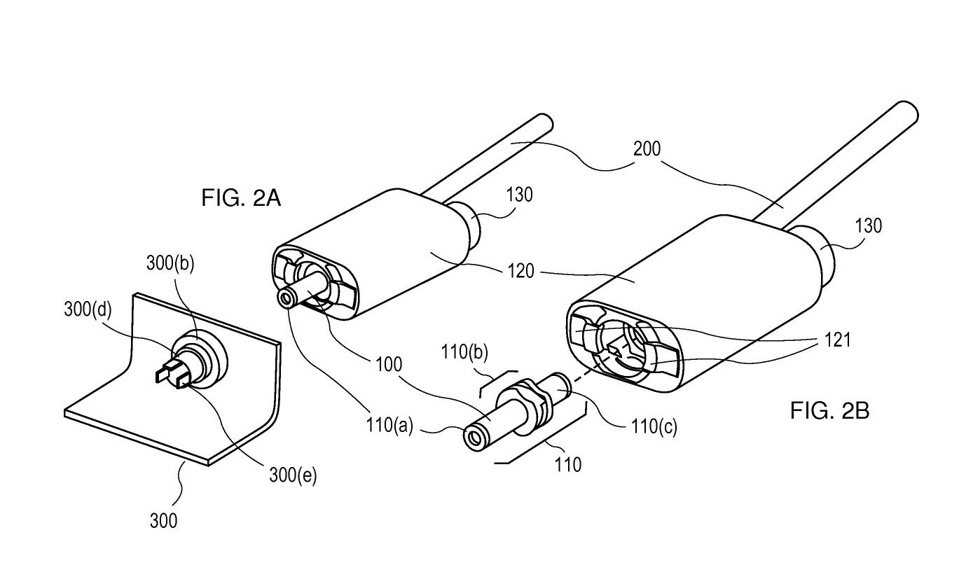

FIG. 2(a) shows a rear perspective view of an attachment device 300(c) and a locking head 120 in accordance with an embodiment of the invention shown in FIG. 1. The portable article housing portion 300 is secured to the attachment device 300(c), which may be capable of providing power and security to the portable article. The attachment device 300(c) may comprise a central port 300(d), which may be a power contact (such as a female power contact). The attachment device 300(c) may have one or more electrical contacts 300(e) within and passing axially through the central port 300(d) to transmit electrical signals to such electrical systems (not shown). The electrical contacts 300(e) of the attachment device 300(c) can be electrically coupled to circuitry of the portable article, such as the power supply. In this example, there are three electrical contacts 300(e) spaced about 120 degrees apart. The electrical contacts in other embodiments of the invention can have different configurations or arrangements.

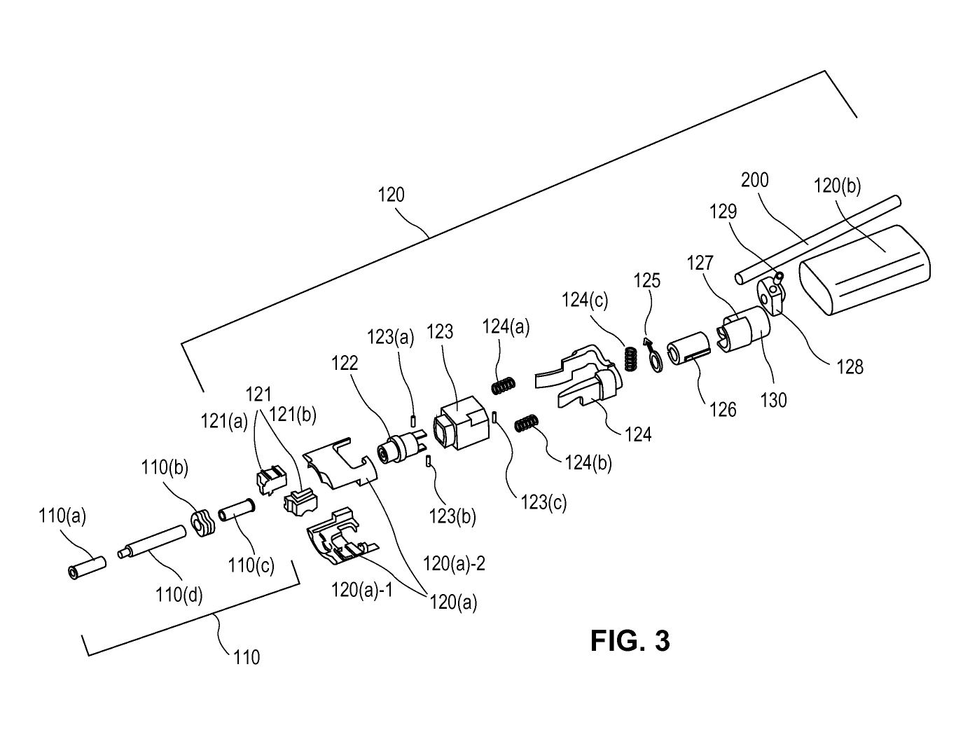

As shown in both FIGS. 2(a) and 2(b), the locking head 120 can include a connector tip 110. The connector tip 110 can comprise a receiving section 110(b), a coupling element 110(c), an electrical connector 100, and an adapter member 110(a). The connector tip 110 can be coupled to the locking head 120 by the coupling element 110(c), which can be inserted into the front opening of the locking head 120. The locking head 120 has an opening for the coupling element 110(c) formed by a first gate assembly 121 (see FIG. 3) that can secure to either or both of the connector tip 110 and the attachment device 300(c), and produce a “click” to indicate that the locking head 120 is fully engaged with the attachment device 300(c) and the connector tip 110. The electrical connector 100 may extend away from the locking head 120 when the coupling element 110(c) is inserted into the front opening of the locking head 120. The electrical connector 100 may be configured in any suitable shape or size to electrically couple with the electrical contacts 300(e) of the attachment device 300(c) through the aperture 300(b) of the portable article housing 300. For example, the electrical connector 100 may be in the form of a power tip, a USB connector, etc. The connector tip 110 may be removable, and the locking head 120 may be configured to accommodate various connectors, to allow for connection to a variety of portable articles.

In certain embodiments, the coupling element 110(c) can couple to a female contact located within the locking head 120, and the first gate assembly 121 may be used to secure to the attachment device 300(c). Power can be transmitted to the locking head 120 through a power cable 200 which may also comprise a security cable (i.e., the power cable 200 can supply power to the portable article and also may be used to secure the portable article to an immovable object). The power cable 200 can comprise any suitable device, such as a metal wire or wires (e.g., copper) surrounded by a Kevlar® sheath (or other type of protective sheath such as a steel sheath). In certain embodiments, the locking head may couple to power cable 200 and a separate security cable (not shown).

FIG. 3 shows an exploded view of the connector tip 110 and the locking head 120 in accordance to the embodiment of the invention shown in FIGS. 1 and 2. The connector tip 110 comprises an adapter member 110(a), a receiving section 110(b), a coupling element 110(c), and a central rod 110(d). The central rod 110(d) is connected (e.g. threaded, pressed, etc.) to the receiving section 110(b) and the adapter member 110(a), and the coupling element 110(c) is connected (e.g. threaded, pressed, etc.) to the central rod 110(d), and receiving section 110(b), to connect all the elements of the connector tip 110 together. The central rod 110(d) may be in the form of a straight rod or may have any suitable size or shape to connect all the elements of the connector tip together and electrically couple to a portable article through the aperture 300(b) of the attachment device 300(c).

The adapter member 110(a) may be configured to extend from the end of the central rod 110(d) and may be in any suitable form to physically couple with the shape and size of the central rod 110(d). The adapter member 110(a) electrically couples to the coupling element 110(c) inside the central rod 110(d) to transfer power through the connector tip 110. The extending portion of the adapter member 110(a) may also have any suitable form to electrically and/or physically couple with the electrical contacts 300(e) of the attachment device 300(c).

The receiving section 110(b) may be in the form of a disk with a hole in the center that is configured to couple with the central rod 110(d). The outer edge of the disk shaped receiving section 110(b) may contain a recess configured to physically couple with a portion of the first gate assembly 121 or the shape of the first housing element 120(a).

The coupling element 110(c) may be wider at its base and have an extending section that matches the shape and size of the central rod 110(d). The extending section of the coupling element 110(c) electrically couples with the adapter member 110(a) inside the central rod 110(d). The base of the coupling element 110(c) may have any suitable shape or size to electrically couple with a power adapter 122 in the locking head 120, described in further detail below.

The connector tip 110 may be configured to transmit (and/or receive) power to a portable article with a corresponding attachment device (not shown). In certain embodiments, the electrical connector 100, for example, the portion of the central rod 110(d) that extends from the receiving section and includes the extended end of the adapter member 110(a), could be configured in any suitable shape or size to electrically couple with the aperture 300(b) of the portable article housing 300.

The connector tip 110 and the electrical connector 100 as disclosed herein provide for numerous advantages. First, the connector tip 110 is removable from the locking head 120 and can be replaced with different sized or shaped connector tips 110 providing different electrical connectors 100 that allow one locking head 120 to electrically couple to many different portable articles 300. This flexibility provides the user with the advantage of using one locking head 120 coupled to a security device 200 for portable devices 300 of many different shapes and sizes. Additionally, the same locking head can be used on multiple devices that require different power inputs by merely replacing the electrical connector 100 and/or connector tip 110. This is less expensive and more efficient for any user who owns more than one portable electronic device. Additionally, portable device manufacturers have the choice of using many different power inputs without alienating any potential customers due to a particular power input being incompatible with their current security apparatus. Furthermore, the connector tip and/or electrical connector is easily replaceable if broken or misplaced. Finally, because the user only has to buy one lock for many different portable devices, the user only has to carry one key for all their portable consumer devices to be secured and powered if the user is only going to use one portable article at any given time.

The locking head 120 further comprises a first housing element 120(a) and a second housing element 120(b). The first housing element 120(a) may comprise one, or more than one component(s). In an exemplary embodiment of the invention shown in FIG. 3, the first housing element 120(a) includes a top first housing element 120(a)-2, and a bottom first housing element 120(a)-1. In certain implementations, the first housing element 120(a) may be located within the second housing element 120(b). Within the first housing element 120(a), there may be a securing element, such as a first gate assembly 121, comprising a first gate structure 121(a) and a second opposed gate structure 121(b). In certain embodiments, one gate (e.g., first gate structure 121(a)) may remain fixed while the other gate (e.g., second opposed gate structure 121(b)) moves inwardly and outwardly. In exemplary embodiments, both first and second gate structures 121(a), 121(b) can move inwardly and outwardly to secure onto the attachment device 300(c). The gate structures 121(a)-(b) may produce a “click” or another sound when fully engaged and secured to indicate to a user that the locking head 120 has successfully electrically coupled and locked with the attachment device 300(c).

Referring again to FIG. 3, the locking head 120 may also have both security and power functionalities, and can include a power element, such as a power adapter 122 to transmit power from the power cable 200 to the connector tip 110. The power adapter 122 includes internal components enabling it to electrically couple (and removably secure to) the coupling element 110(c) of the connector tip 110. The power cable 200 can connect to a power housing 123 within the second housing element 120(b), which may in turn connect to the power adapter 122 on the opposite side. The housing components may be held together by assembly screws 123(a)-(c).

The second housing element 120(b) can also contain securing elements, such as a second gate assembly 124, that can lock or unlock based on movements from biasing elements, such as springs 124(a)-(c), or a first lock plate 125. The first lock plate 125 may comprise an actuator 125(a) attached to a main body 125(b) with a central hole, and lies between the second gate assembly 124 and at least a portion of a locking component 126 and lock holder assembly 127. When assembled together, in some embodiments, at least a portion of the actuator 125(a) can be disposed within the spring 124(c). The locking component 126 may comprise a cam (or other structure) which at least partially extends forward and passes through the central hole of the first lock plate 125, or may engage with the first lock plate 125. The locking component 126 and the first lock plate 125 can rotate together in this configuration. The locking component 126 may house a number of disks in the form of a disk locking component, or other suitable locking systems. Although one specific locking component is shown in FIG. 3, it is understood that other types of locking components (e.g., a tumbler and pin locking component, disk locking component, etc.) can be used in other embodiments of the invention.

A second lock plate 128 is at a rear region of the second housing element 120(b) and may be held in place with a locking pin 129. A ferrule 130 that contains an opening to provide key access to the locking component 126 can protrude outside of the second housing element 120(b).

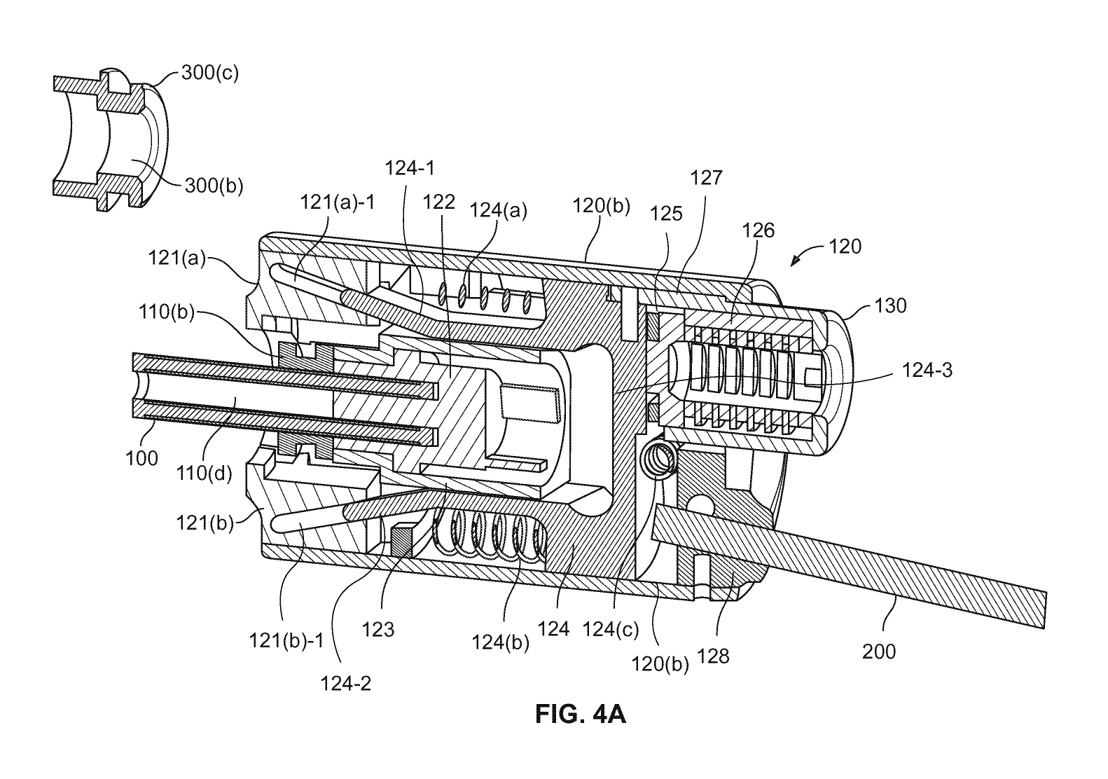

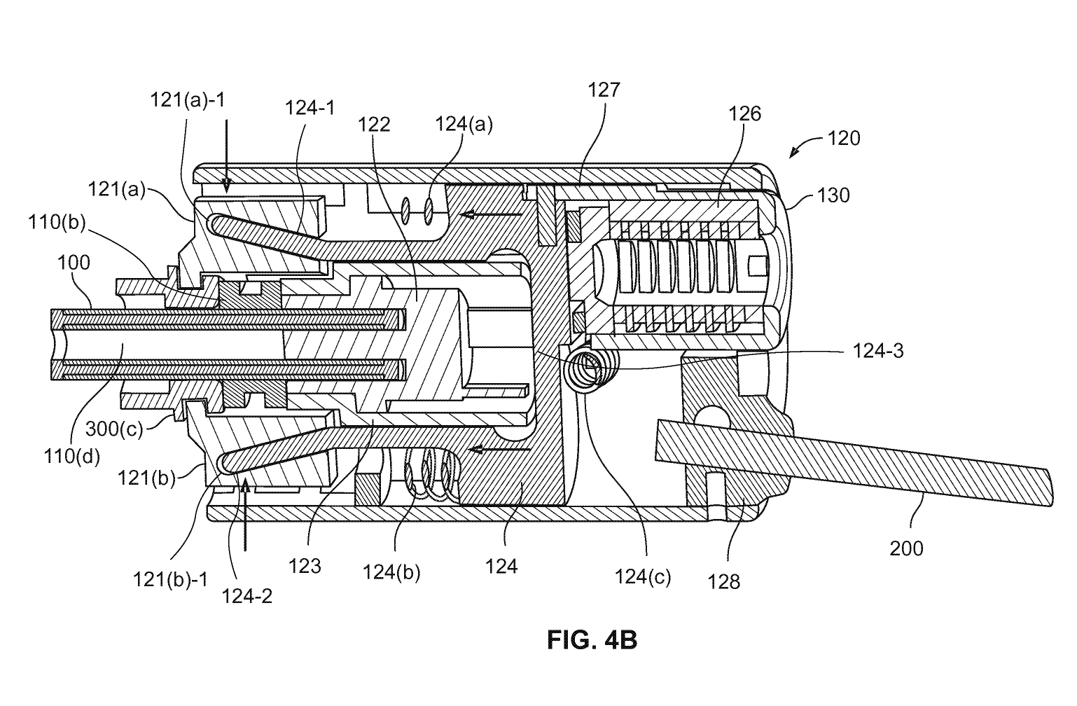

The operation of security apparatuses disclosed herein can be described with reference to FIGS. 4A-7. In embodiments of the invention, a method for using the security apparatus may comprise: obtaining a portable article and an attachment device attached to the portable article. The method may comprise attaching a locking head to the attachment device. The locking head may comprise (i) a housing, (ii) an electrical connector configured to electrically couple the locking head with the attachment device, (iii) a first gate assembly (or other suitable securing element) within the housing and configured to engage the base of the attachment device, (iv) a second gate assembly (or other suitable securing element) within the housing and configured to engage the first gate assembly (or other suitable securing element), (v) a plurality of biasing elements (where at least one lock biasing element is configured to keep the lock in a secured configuration when the locking head is secured to the attachment device, and where at least one return biasing element is configured to keep the lock in an unsecured configuration when the locking head is not secured to the attachment device), (vi) a power adapter, where the power adapter is configured to electrically couple to a power source, and (vii) a locking component inside of the housing. The method may also include securing the security apparatus to an immovable object, where the security apparatus is also connected to a power source. The locking component can be in a locked configuration after the locking head is attached to the attachment device (without requiring a key).

Referring to FIG. 4A, the attachment device 300(c) can be first secured to a portable article as described above. The locking head 120 can be positioned toward the attachment device 300(c) such that the electrical connector 100 extending from the power adapter 122 inside of the locking head 120 is aligned with the aperture 300(b). In FIG. 4A, the return biasing elements 124(a), 124(b) bias the first gate assembly 121 and the second gate assembly 124 radially away from one another in the absence of applied force. Both the first gate structure 121(a) and second gate structure 121(b) of the first gate assembly 121 may define a recess that is configured to match the shape of the outer portion of the attachment device 300(c) (see FIG. 4B) in a locked configuration.

FIG. 4(a) shows an embodiment of the invention in an unlocked and unsecured configuration, while FIG. 4(b) shows the embodiment of the invention in a locked configuration.

As shown in FIG. 4A, the first gate assembly 121 may have a first guide cavity 121(a)-1 and a second guide cavity 121(b)-1, respectively associated with the first gate structure 121(a) and the second gate structure 121(b). The first guide cavity 121(a)-1 and the second guide cavity 121(b)-1 can extend from rear surfaces of the first and second gate structures 121(a), 121(b), respectively. They may also be gradually angled radially outward (e.g., greater than 1, but less than 60 degrees) with respect to an axis passing through an axis X passing through the locking head 120.

In FIG. 4(a), the locking head 120 is physically separated from the attachment device 300(c). The first and second gate structures 121(a), 121(b) are separated a sufficient distance such that the attachment device 300(c) can be inserted between the first and second gate structures 121(a), 121(b), but around the electrical connector 100.

The first and second guide cavities 121(a)-1, 121(b)-1 can also be configured to house respective pairs of arms 124-1, 124-2 of the second gate assembly 124. The arms 124-1, 124-2 can be physically coupled to, perpendicular to, and integral with a base 124-3 of the second gate assembly 124.

As shown in FIG. 4B, when force is applied to the ferrule 130 in the direction of the attachment device 330(c) (along the axis X), the lock holder assembly 127, the locking component 126, the first lock plate 125, and the second gate assembly 124 are pushed toward the front of the locking head 121. The return biasing elements 124(a), 124(b) are compressed by the force. The first guide cavity 121(a)-1, the second guide cavity 121(b)-1, and the second gate assembly 124 are configured so that the second gate assembly 124 (and its arms 124-1, 124-2) slides forward along the pair of guide cavities 121(a)-1, 121(b)-1, and the first gate structure 121(a) and the second gate structure 121(b) are pushed inward toward each other. Once the second gate structure 124 is pushed to the ends of the first and second guide cavities 121(a)-1, 121(b)-1 in the first gate assembly 121, the first gate structure 121(a) and second gate structure 121(b) of the first gate assembly 121 engage the attachment device 300(c). The angled arms 124-1, 124-2 gradually push the first and second gate structures 121(a), 121(b) toward each other as they slide in the angled guide cavities 121(a)-1, 121(b)-1. This engagement prevents withdrawal of the attachment device 300(c) from the locking head 120.

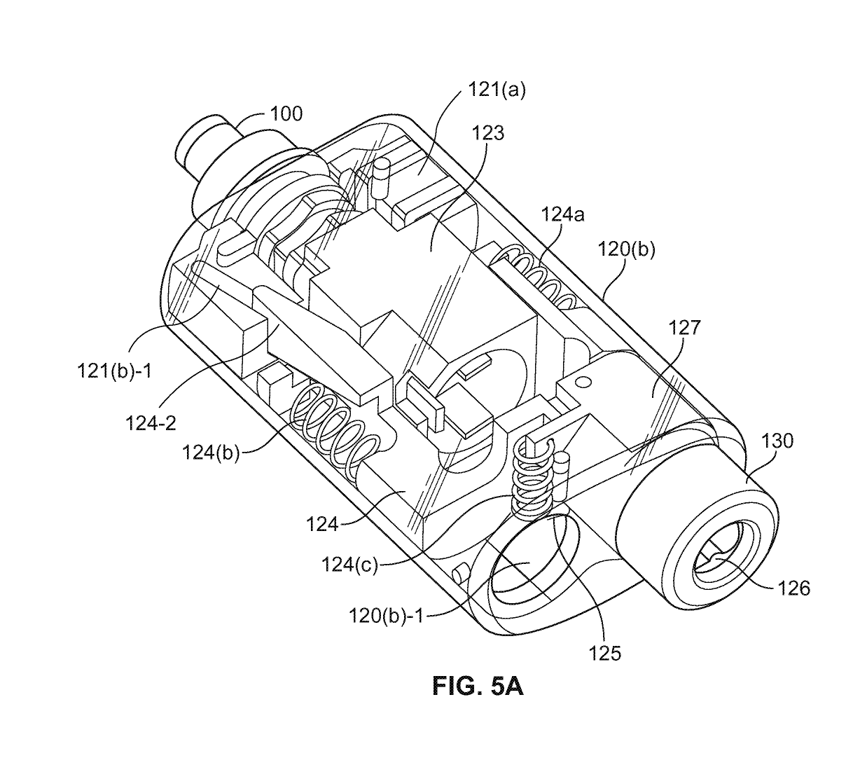

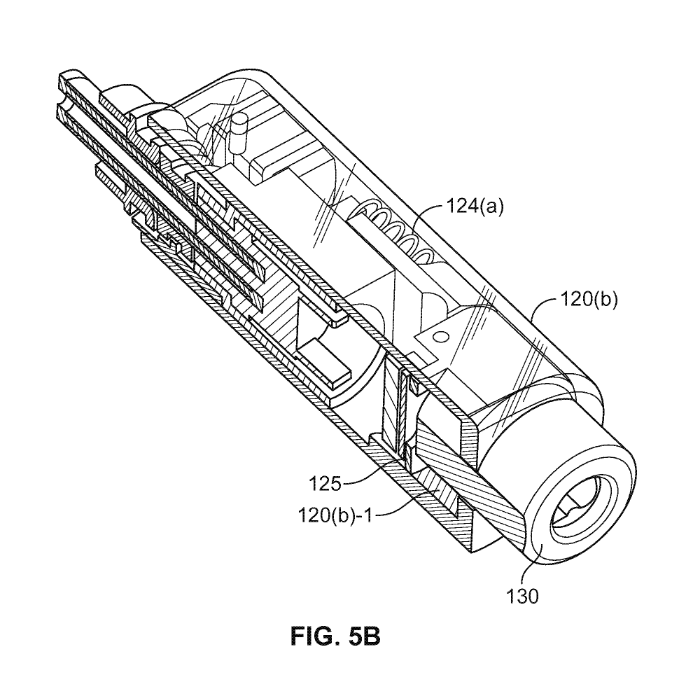

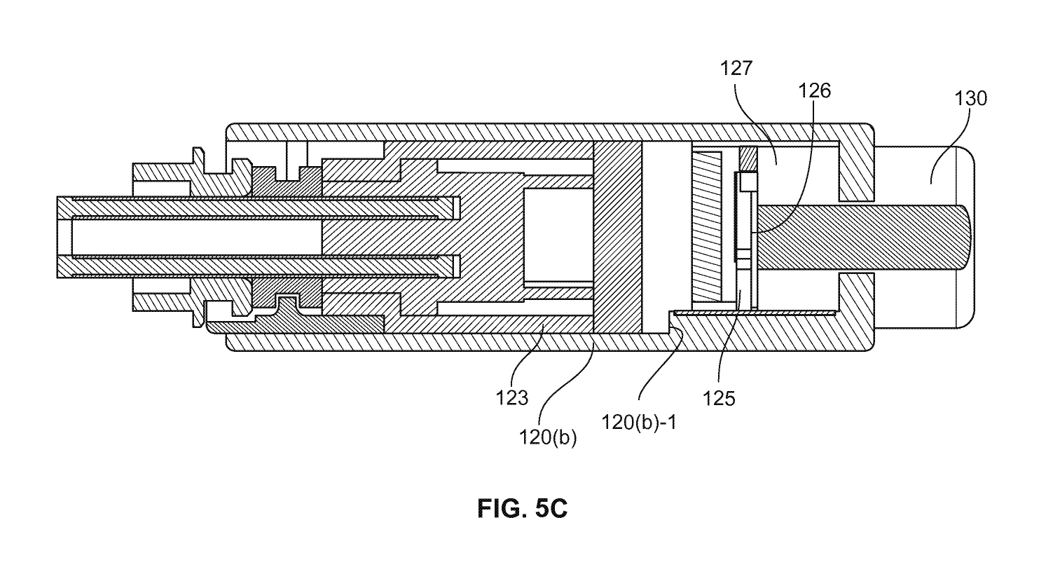

FIGS. 5A-5C show various views of the locking head 120 in the unlocked configuration. When force is not applied to the ferrule 130, the return biasing elements 124(a), 124(b) push on the second gate assembly 124 separating the first gate assembly 121 and the second gate assembly 124 as much as the second housing element 120(b) will allow. However, the second gate assembly 124 does not lose contact with the first guide cavity 121(a)-1 or the second guide cavity 121(b)-1. The second housing element 120(b) may have a raised ridge 120(b)-1 (or other blocking structure) along the back inside wall of the second housing element 120(b) configured with a vertical step large enough to hold the actuator of the first lock plate 125 in a locked configuration. In the unlocked configuration, the first lock plate 125 is biased downward by the lock biasing element 124(c) but its forward or backward movement is not constrained by the step of the raised ridge 120(b)-1.

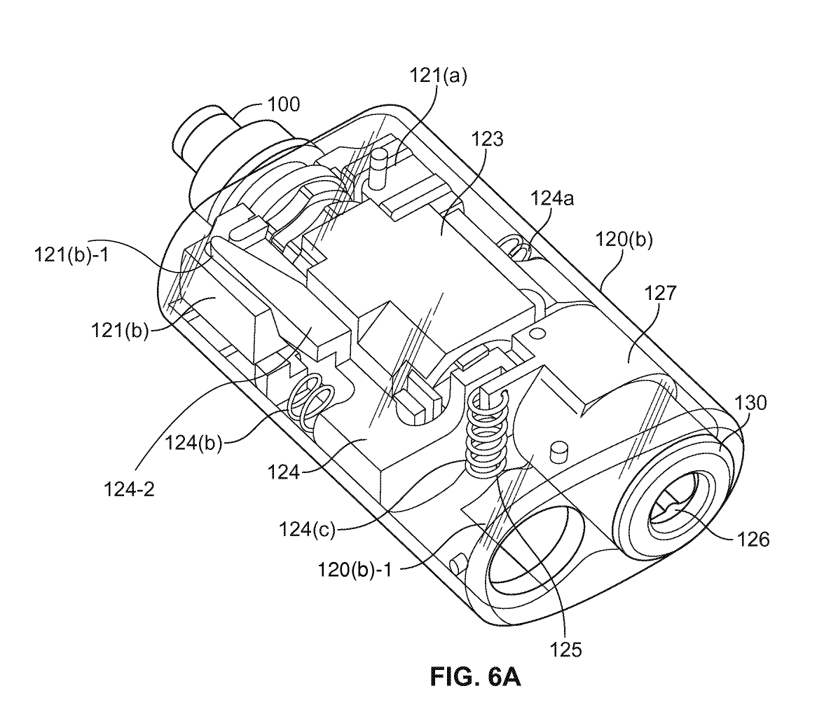

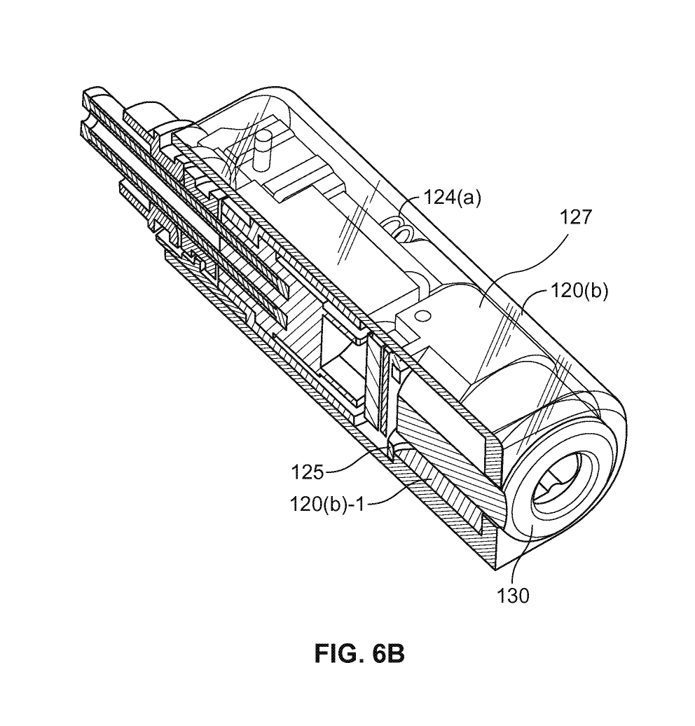

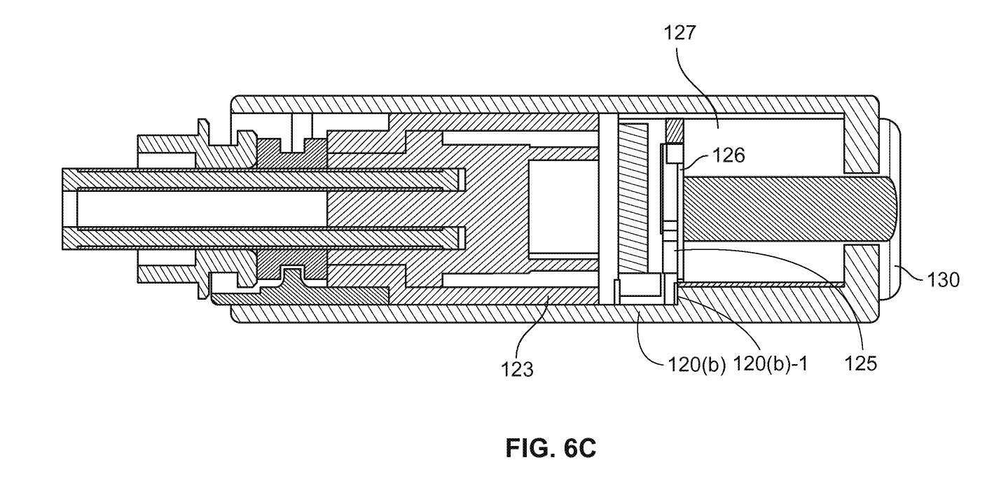

FIGS. 6A-6C show various views of the locking head 120 in the locked configuration. When sufficient force is applied to the ferrule 130 to push the second gate assembly 124 to the end of the first and second guide cavities 121(a)-1, 121(b)-1 in the first gate assembly 121, the locking head 120 is in its locked configuration and the first lock plate 125 is pushed past the vertical step of the raised ridge 120(b)-1. The lock biasing element 124(c) pushes the actuator of the first lock plate 125 downward against the inside wall of the second housing element 120(b) and the raised ridge 120(b)-1 of the second housing element 120(b) constrains the backward movement of the first lock plate 125 such that the ferrule 130, the lock holder assembly 127, and the second gate assembly 124 are held in their forward locked configuration. The actuator of the first lock plate 125 biased against the wall of the second housing element 120(b) and held in place by the raised ridge 120(b)-1 of the second housing element 120(b) will keep the locking head in the locked configuration until the locking component 126 is unlocked using a key.

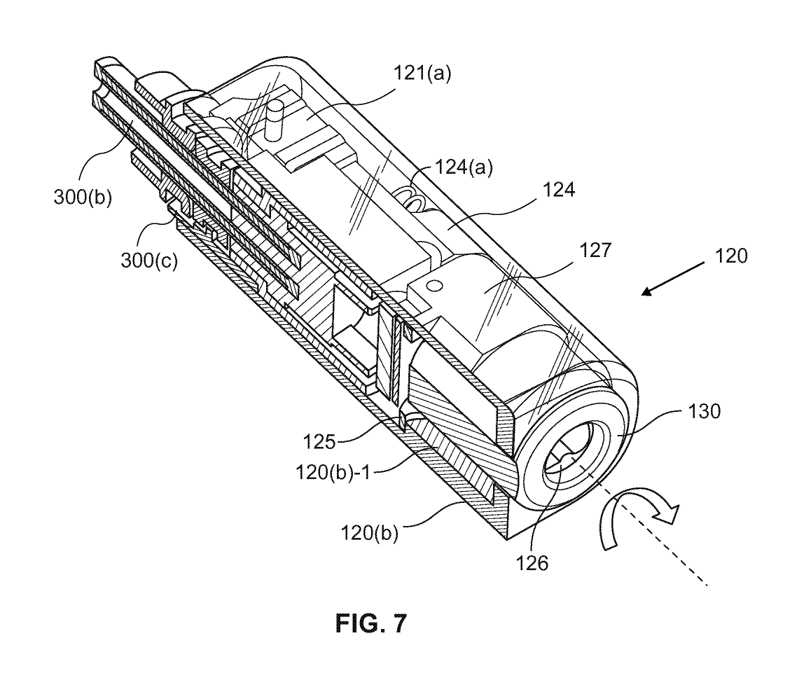

FIG. 7 shows how the locking head 120 can be separated from the attachment device 300(c). An authorized key (not shown) is inserted into the ferrule 130 to unlock the locking component 126 in the locking head 120. The key can rotate the locking component 126 which rotates the cam on the end of the locking component 126 attached to the first lock plate 125. The actuator of the first lock plate 125 is rotated against the force of the lock biasing element 124(c) until the actuator of the first lock plate 125 is raised above the height of the raised ridge 120(b)-1. The actuator of the first lock plate 125 that was constrained against the raised ridge 120(b)-1 is then released from the raised ridge 120(b)-1 and the return biasing elements 124(a), 124(b) push the second gate assembly 124, the first lock plate 125, the locking component 126, the lock holder component 127, and the ferrule 130 back to the unlocked configuration. As the second gate assembly 124 is pushed away from the end of the first and second guide cavities 121(a)-1, 121(b)-1 of the first gate assembly 121, the first gate structure 121(a) and second gate structure 121(b) move away from each other and release the outer portion of the attachment device 300(c) from the recess defined by the first gate assembly 121. This unlocks the locking head 120 and the outer portion of the attachment device 300(c) and allows removal of the electrical connector 100 from the aperture 300(b). This allows the locking head 120 to be removed from the attachment device 300(c), such as to allow for transport of the previously secured portable article 300.

Embodiments of the locking heads as disclosed herein provide for improved methods of locking and unlocking. For example, in certain embodiments, no key may be necessary to lock the locking head against the attachment device. The locking head may be capable of securing to the attachment device upon a single movement of the locking head, using the securing element. Thus, the locking head may be secured to the attachment device such that the locking head (e.g., the locking component) is in a locked configuration (i.e., a secured configuration, while secured to the attachment device) without the use of a key; rather, only a single motion (e.g., a single linear motion, a single rotational motion, etc.), such as sliding the locking head toward the outer portion of the attachment device with sufficient force on the ferrule of the locking head may be used. Therefore, the locking head may be in a locked configuration upon a single movement of the locking head and ferrule. The locking head may indicate it is then in the locked configuration by producing a sound, such as a “click.” The locking heads disclosed herein are therefore quite user friendly. Less effort is required to secure a portable article, and a user may be assured that the locking head is properly in place.

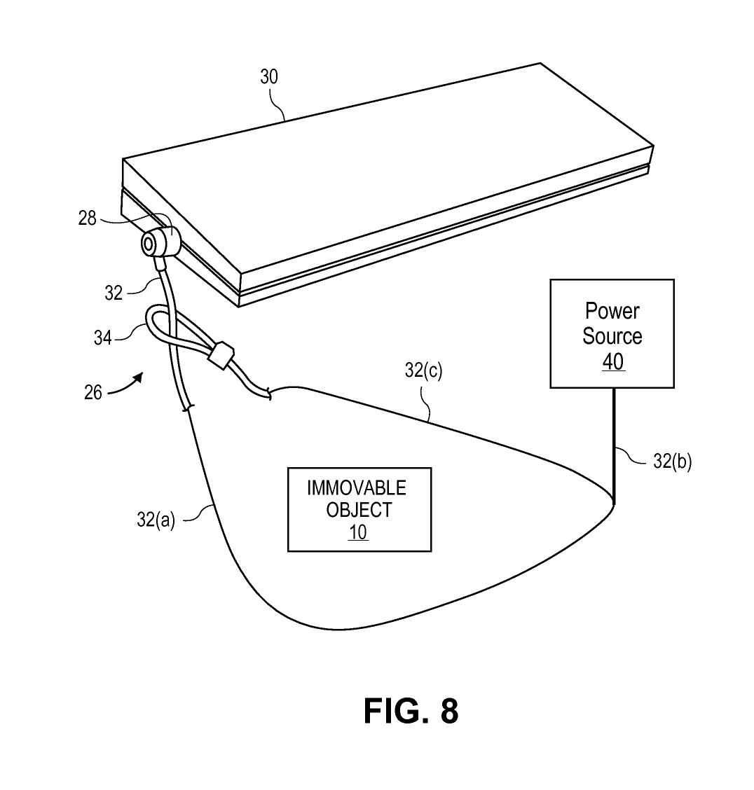

FIG. 8 shows a system comprising a portable article 30 and a security apparatus 26 that is used to secure the portable article 30 to an immovable object 10 such as a desk leg or the like. The security apparatus 26 comprises a head 28 and a cable 32 coupled to the head 28, which may be a locking head in this example. A loop 34 is at a terminal end of the head 28. The cable 32 may comprise a first cable section 32(a), a second cable section 32(b), and a third cable section 32(c). The first cable section 32(a) and the third cable section 32(c) may comprise a strong material such as stainless steel or Kevlar®. The second cable section 32(b) may or may not comprise a strong material such as stainless steel or Kevlar®. The first cable section 32(a) and the third cable section 32(c) may be physically coupled so the portable article 30 is secured to the immovable object 10. The second cable section 32(b) may be electrically coupled to a power source 40. For example, the second cable section 32(b) may comprise a power plug configured to plug into a wall power outlet. The first cable section 32(a) and the second cable section 32(b) are electrically coupled so that an electrical signal may be transferred from the power source 40, through the second cable section 32(b) and the first cable section 32(a) to the portable article 30. Any suitable power source 40 (e.g. an outlet or battery) may be used to supply power to the portable article 30 through the cable 32.

It is also understood that embodiments of the invention may include other variations. For example, the power source 40 in FIG. 8 could alternatively be a peripheral device (e.g., a monitor) that receives power and/or data from the portable article 30. In yet other embodiments, the power source 40 could alternatively be a data source such as a wire from a router.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. Where approximate or “about” is described for measurements, embodiments herein also contemplate the exact measurement. Where a shape is disclosed, such as a cylinder, embodiments herein contemplate other suitable shapes, such as multi-sided blocks (octagonal structures, decagonal structures, etc.), other rectangular structures, etc. In certain implementations, structures with multiple sides approaching the shape of cylinders, as well as substantially cylindrical shapes (e.g., a cylinder with a flat sidewall portion) may be considered cylinders as described herein, unless otherwise specified.

A recitation of “a”, “an” or “the” is intended to mean “one or more” unless specifically indicated to the contrary.

What is claimed is:

1. A security apparatus comprising:
an attachment device configured to attach to a portable article; and
a locking head configured to secure to the attachment device, wherein the locking head comprises an electrical connector that is capable of being electrically coupled to the attachment device.

2. The security apparatus of claim 1, wherein the portable article comprises a portable electronic device.

3. The security apparatus of claim 1, wherein the locking head is configured to provide power to the portable article through the attachment device, and wherein the attachment device comprises an aperture that passes through an axial dimension of the attachment device.

4. The security apparatus of claim 1 wherein the electrical connector is part of a connector tip.

5. The security apparatus of claim 4 wherein the connector tip is removable, and is one of many connector tips of different sizes that can be configured to connect to different attachment devices or different portable articles.

6. The security apparatus of claim 5 wherein the connector tip includes a central rod, a coupling element, and an adapter member coupled together.

7. The security apparatus of claim 1 wherein the attachment device is capable of being removably coupled to the portable article via an aperture in the portable article.

8. The security apparatus of claim 1 wherein the locking head comprises a plurality of gate structures that can engage the attachment device.

9. The security apparatus of claim 1 wherein the locking head comprises a key locking component.

10. The security apparatus of claim 1 wherein the attachment device further comprises a plurality of electrical contacts.

11. A locking head comprising:
a housing;
a locking component in the housing;
an electrical connector exposed by the housing; and
at least two coupling elements configured to engage an attachment device attached to a portable article.

12. The locking head of claim 10 wherein the locking component is a key locking component.

13. The locking head of claim 10 wherein the coupling elements are gate structures.

14. The locking head of claim 12 wherein the gate structures are in an opposing relationship.

15. The locking head of claim 10 wherein the electrical connector is part of a connector tip.

16. The locking head of claim 14 wherein the connector tip is removable, and is one of many connector tips of different sizes that can be configured to connect to different attachment devices or different portable articles.

17. A method for using the security apparatus of claim 1 comprising:
attaching the locking head to the attachment device, thereby electrically coupling the locking head to the attachment device and the portable article.

18. The method of claim 17 wherein the portable article is a portable electronic device.

19. The method of claim 17 wherein the locking head is configured to provide power to the portable article through the attachment device, and wherein the attachment device comprises an aperture that passes through an axial dimension of the attachment device.

20. The method of claim 16 wherein the electrical connector is part of a connector tip.
